(19) United States
(12) Patent Application Publication
(10) Pub. No.: US 2025/0029279 A1
(43) Pub. Date: Jan. 23, 2025

(54) Camera Calibration Method and Apparatus

(71) Applicants: Hyundai Motor Company, Seoul (KR); Kia Corporation, Seoul (KR)

(72) Inventors: Jung Hyun Lee, Seoul (KR); Min Young Yoon, Seoul (KR); Tae Hun Lim, Seoul (KR)

(21) Appl. No.: 18/520,145

(22) Filed: Nov. 27, 2023

(30) Foreign Application Priority Data
Jul. 19, 2023 (KR) 10-2023-0094095

(51) Int. Cl. G06T 7/80; G06T 7/13; G06T 7/62; G06T 7/70; G06V 10/44

(52) U.S. Cl. CPC G06T 7/80; G06T 7/13; G06T 7/62; G06T 7/70; G06V 10/44; G06T 2207/30244

(57) ABSTRACT

A camera calibration method comprises receiving an image captured by a camera of a vehicle, detecting a vehicle body area of the vehicle from the image, and estimating a posture of the camera based on the vehicle body area.

### CROSS-REFERENCE TO RELATED APPLICATION

This application claims the benefit of priority to Korean Patent Application No. 10-2023-0094095, filed in the Korean Intellectual Property Office on Jul. 19, 2023, the entire contents of which are incorporated herein by reference.

### TECHNICAL FIELD

The present disclosure relates to camera calibration technology, and more particularly, to a camera calibration method and apparatus capable of estimating a posture of a camera based on a vehicle shape or vehicle body area of a vehicle captured while the vehicle is driving.

### BACKGROUND

Various image recognition technologies are required to operate an autonomous vehicle. For example, to identify lanes and identify vanishing points while a vehicle is driving is important.

The vanishing point refers to a point at which, if parallel straight lines in a 3-dimensional (3D) space are infinitely extended and projected onto a 2-dimensional (2D) plane, the straight lines meet on the plane. As an example of utilizing detection of the vanishing point, a building may be reinterpreted by analyzing an architectural structure by obtaining vanishing points and vanishing lines in three orthogonal directions. In 3D transformation of a 2D image including architectural structures, a depth map may be generated by detecting a vanishing point. The reason for this is that estimation of a relative depth is possible because a part where the vanishing point is located generally corresponds to the farthest part in the image as a 3D space is transformed into a 2D image.

In addition, vanishing point information may be a reference for lane detection in an autonomous vehicle or an important basis for analyzing location information in an autonomous driving system such as a robot. This is because a road can be detected by connecting major edges connected from the vanishing point.

The vehicle estimates vanishing points with line segments in an image while driving and estimates one vanishing line based on the estimated vanishing points to estimate extrinsic parameters of a camera and a road surface, thus estimating a posture of the camera.

However, there is a problem in that the accuracy of vanishing points is lowered due to image distortion while the vehicle is driving, and it is difficult to accurately estimate the vanishing line due to the bounding of vanishing points according to the behavior of the vehicle while driving.

### SUMMARY

The following summary presents a simplified summary of certain features. The summary is not an extensive overview and is not intended to identify key or critical elements.

Systems, apparatuses, and methods are described for a calibrating a camera of a vehicle. A method may comprise receiving an image captured by a camera of a vehicle; detecting, in the image, a vehicle body area of the vehicle; estimating, based on a slope of an edge associated with the vehicle body area, a posture of the camera; and performing image recognition on a calibrated image, wherein the calibrated image is based on a second image acquired by the camera calibrated based on the estimated posture of the camera.

Also, or alternatively, an apparatus may comprise a receiver configured to receive an image captured by a camera of a vehicle; a detector configured to detect, in the image, a vehicle body area of the vehicle; and an estimator configured to estimate, based on a slope of an edge associated with the vehicle body area, a posture of the camera. The apparatus may be configured to perform image recognition on a calibrated image, wherein the calibrated image is based on a second image acquired by the camera calibrated based on the estimated posture of the camera.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 shows an operational flowchart for a camera calibration method of the present disclosure;

FIG. 2 shows an operational flowchart of an example of a process of detecting a vehicle body area of a vehicle;

FIG. 3 shows an operational flowchart of an example of a process of estimating a camera roll;

FIG. 4 shows an example diagram for describing a process of estimating a camera roll;

FIG. 5 shows an operational flowchart of an example of a process of estimating a camera pan;

FIG. 6 shows an example diagram for describing the process of estimating the camera pan;

FIG. 7 shows an example diagram for describing relationship between an image domain and a Gaussian sphere domain;

FIG. 8 shows an operational flowchart of an example of a process of estimating a camera tilt;

FIG. 9 shows an example diagram for describing a process of estimating a camera tilt;

FIG. 10 shows an example diagram for describing a method for estimating a camera posture in an example that violates the Manhattan World Assumption (MWA);

FIG. 11 shows an example diagram to explain a method of estimating a camera posture in another example that violates the Manhattan World Assumption (MWA);

FIG. 12 shows the configuration of a camera calibration device according to another example of the present disclosure; and

FIG. 13 is a block diagram of a computing system for executing a camera calibration method according to an example of the present disclosure.

### DETAILED DESCRIPTION

Hereinafter, with reference to the accompanying drawings, the present disclosure will be described in detail such that those of ordinary skill in the art can easily carry out the present disclosure. However, the present disclosure may encompass several different forms and is not limited to the examples described herein.

In describing the present disclosure, if it is determined that a detailed description of a known configuration or function may obscure the gist of the present disclosure, a detailed description thereof will be omitted. Further, in the drawings, parts not related to the description of the present disclosure are omitted, and similar reference numerals are attached to similar parts.

It will be understood that if an element is referred to as being “connected,” “coupled,” or “fixed” to another element, it can be directly connected or coupled to the other element or intervening elements may be present. In addition, unless explicitly described to the contrary, the word “comprise” or “include” will be understood to imply the inclusion of stated elements but not the exclusion of any other elements.

In the present disclosure, the terms such as “first” and “second” are used only for the purpose of distinguishing one element from other elements, and do not limit the order or importance of the elements unless specifically mentioned. Therefore, within the scope of the present disclosure, a first element in one example may be referred to as a second element in another example, and similarly, the second element in one example may be referred to as the first element in another example.

In the present disclosure, distinct elements are only for clearly describing their features, and do not necessarily mean that the elements are separated. That is, a plurality of elements may be integrated to form one hardware or software unit, or one element may be distributed to form a plurality of hardware or software units. Accordingly, even if not specifically mentioned, such integrated or distributed examples are also included in the scope of the present disclosure.

In the present disclosure, elements described in various examples do not necessarily mean essential components, and some may be optional elements. Accordingly, examples consisting of a subset of the elements described in one example are also included in the scope of the present disclosure. Additionally, examples that include other elements in addition to the elements described in the various examples are also included in the scope of the present disclosure.

In the present disclosure, expressions of positional relationships used in the specification, such as top, bottom, left, or right, are described for convenience of description, and if the drawings shown in the specification are viewed in reverse, the positional relationships described in the specification may also be interpreted in the opposite way.

In the present disclosure, phrases such as “A or B”, “at least one of A and B”, “at least one of A or B”, “A, B or C”, “at least one of A, B and C”, “at least one of A, B, or C” may include any one of items listed together in the corresponding phrase, or any possible combination thereof.

To solve the problem of difficulty in estimating an accurate vanishing line while a vehicle (e.g., a vehicle comprising and/or connected to a camera) is driving, the present disclosure provides systems, apparatuses and methods for detecting a vehicle shape and/or vehicle body area, of the vehicle, captured by the camera. The vehicle shape and/or vehicle body area may comprise some or all of a handle, a bonnet, and/or the side of the vehicle. Methods disclosed herein may improve the estimation accuracy of the posture of the camera, for example, three-axis angles (roll, pan, tilt) of the camera, by using the detected vehicle shape and/or vehicle body area as a reference, instead of or in addition to a vanishing line and/or a vanishing point.

The present disclosure may estimate a camera posture based on the Manhattan World Assumption (MWA) for transformation between an image domain and a Gaussian sphere domain. Specifically, the present disclosure may estimate a camera pan based on the included angle between the camera optical axis and a straight line in the vehicle body area using MWA. The present disclosure may estimate a camera tilt based on the included angle between the camera optical axis and a feature point vector, such as a vector corresponding to a feature point associated with (e.g., of) a handle.

The present disclosure may use the analyzed (e.g., determined) vehicle body area as a substitute for, and/or a supplement to, a vanishing point and/or vanishing line. The vehicle body area, of the vehicle, detected in an image may be analyzed and thus used to estimate the posture of the camera.

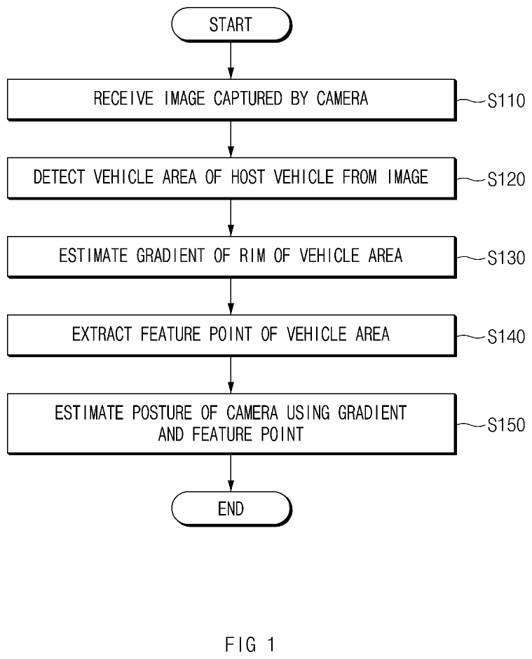

Hereinafter, a method and device according to the present disclosure will be described with reference to FIGS. 1 to 12.

FIG. 1 is an operational flowchart illustrating a camera calibration method according to an example of the present disclosure, which may be performed by a camera calibration device. The camera calibration device may be provided in the vehicle and/or may be remote from the vehicle (e.g., in communication with and/or capable of receiving information from and/or transmitting information to the vehicle). The camera calibration device may be capable of communicating with a camera of the vehicle, for example.

Referring to FIG. 1, a camera calibration method according to an example of the present disclosure may include receiving (e.g. in real-time or near real-time) an image captured by an image photographing means, for example, a camera while a vehicle is driving, and detecting a vehicle body area (e.g., an area of the image corresponding to an image of a portion of the vehicle) of the vehicle from the received image (S110 and S120).

In S110, an image captured by at least one camera (e.g., at least one of a front camera, a rear camera, a front corner camera, and/or a rear corner camera) may be received. In the examples discussed herein, an image captured by the rear corner camera may be received.

In S120, a vehicle body area of the vehicle may be detected in the image. For example, one or more edge points may be detected in a series of images from the camera, and the one or more edge pointe may be determined to not change substantially over time (e.g., whereas other areas of the image(s) may appear to change and/or move over time). Other edge detection methods may also, or alternatively, be used to detect an edge and/or edge point (s) of the vehicle body area. An edge of the detected vehicle body area in the image may be determined based on position(s) the detected edge points.

Based on the vehicle body area being detected in S120, a slope of the edge of the detected vehicle body area may be estimated, feature points of the detected vehicle body area may be extracted, and/or the posture of the camera may be estimated. For example, the roll, pan and tilt 3-axis angles may be estimated (S130, S140, and S150).

In S150, the roll of the camera may be estimated based on the estimated slope, the pan of the camera may be estimated based on the position of the edge of the vehicle body area, and the tilt of the camera may be estimated based on the feature point of the vehicle body area, thus estimating the posture of the camera.

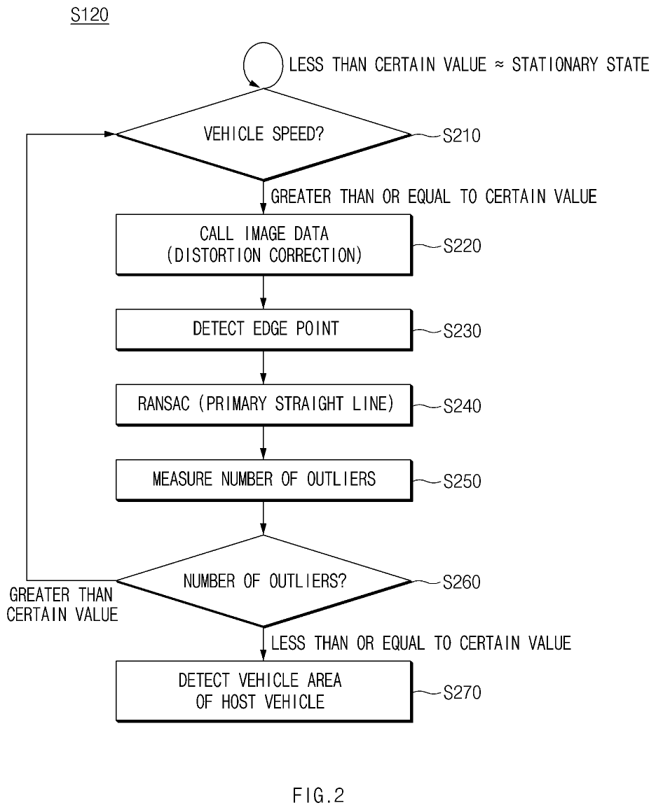

A method according to an example of the present disclosure will be described in detail with reference to FIGS. 2 to 9.

FIG. 2 is an operational flowchart of an example of a process of detecting a vehicle body area of a vehicle, and is an operational flowchart of an example of S120 of FIG. 1.

Referring to FIG. 2, the detecting of the vehicle body area of the vehicle (S120) may include calling or receiving image data captured by a camera while the vehicle is driving at a certain speed or higher, correcting an image distortion, and then detecting edge points in the image in which the distortion is corrected (S210, S220, and S230).

Because it is hard to identify time-invariant edge points (e.g., that do not change with time between successive images) if the vehicle is in a stationary state, edge points may be detected from an image based on the speed of the vehicle being greater than or equal to a predetermined value.

If the edge points in the image are detected in S230, a first straight line for the edge points may be extracted to determine the number of outliers by applying a specific logic, for example, an AND logic to the edge points detected over time, and applying RANSAC (random sample consensus) to the edge points to which the AND logic has been applied (S240).

The applying of the AND logic to the edge points in S240 may be for easily detecting the vehicle body area because the positions of the edge points of the vehicle body area are kept even if the vehicle is moving or driving, but the edge points detected outside the vehicle body area are moving.

Here, RANSAC is an algorithm for removing noise from a dataset and predicting a model and has the characteristic of completely ignoring data above a certain threshold, making it robust against outliers. For example, RANSAC may extract an ideal model having no noise and the maximum data is identical (e.g., a first-order straight line). The RANSAC is known to those skilled in the art, and therefore, a detailed description thereof will be omitted.

For an area of the image, if a first straight line for the edge points therein is extracted in S240, the number of outliers may be measured using a result of RANSAC. the number of outliers is less than a preset certain value, the corresponding edge points may be determined as the vehicle body area of the vehicle. Through this process, the vehicle body area of the vehicle may be detected (S250, S260, and S270). For example, because an outlier exceeding the certain value, that is, a large number of outliers means that an edge point has been detected in an area other than the vehicle, the edge point in the corresponding area may be determined as an edge point of the vehicle body area if the outlier is less than or equal to the certain value.

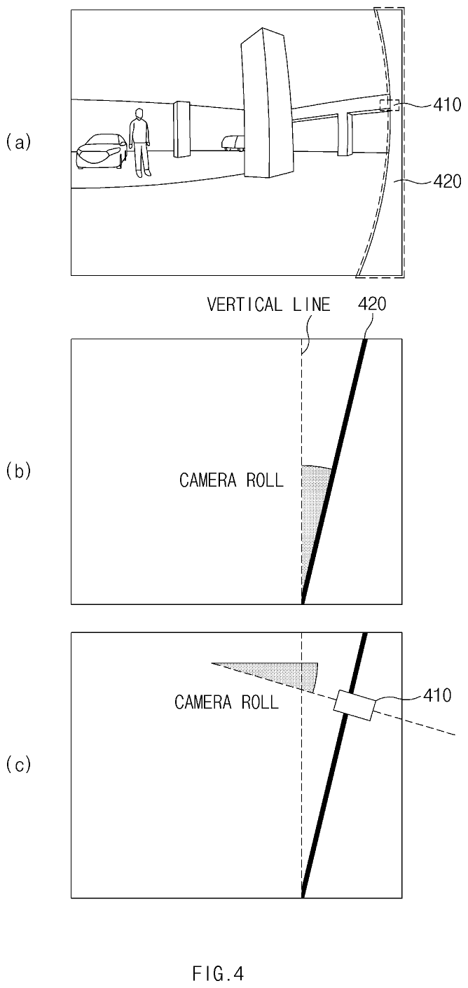

For example, if an image captured by the camera is as shown in FIG. 4A, an area 400 of the vehicle may be detected, via the process of FIG. 2, as the vehicle body area. In this case, the area 400 of the vehicle may include a handle area 410 corresponding to a feature point, as shown in FIG. 4A.

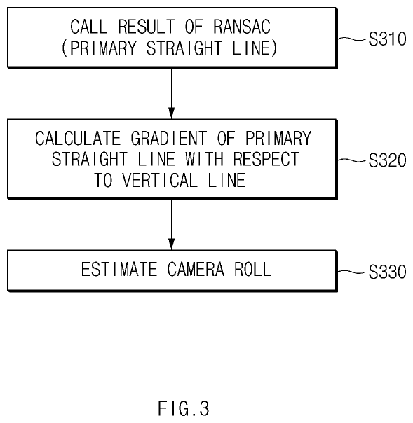

FIG. 3 is an operational flowchart of a process of estimating a camera roll, for example, based on a vehicle body area detected via the process of FIG. 2.

Referring to FIG. 3, a process of estimating a camera roll may estimate the camera roll by calling a first-order straight line, which is a result of RANSAC for the detected edge points of the vehicle body area and calculating an slope of the first-order straight line for the vehicle body area with respect to a vertical line (S130, S320, and S330).

In S330, the slope of the first-order straight line for the vehicle body area may be estimated as the camera roll because the side of the vehicle is assumed to be perpendicular to the road surface in a 3D space and the slope of the vehicle body area is assumed as the camera roll. For example, as shown in FIG. 4B, a slope of the straight line 420 of the edge of the vehicle body area, that is, the slope of the straight line 420 of the edge of the vehicle body area with respect to the vertical line may be estimated as the camera roll.

In S330, the slope of the first straight line with respect to the vertical line may be determined (e.g., calculated), a histogram of a gradient of the image may be generated to output a slope corresponding to the peak of the histogram, and the slope may be then rotated by 90 degrees, thus estimating the camera roll.

In S330, the camera roll may be estimated using feature points (e.g., and/or feature point vectors and/or feature point lines) included (e.g., detected) in the vehicle body area. As shown in FIG. 4C, the camera roll may be estimated using the handle area 410, which is a feature included in the vehicle body area. For example, because the handle area 410, which is the feature included in the vehicle body area, forms a right angle with the edge of the vehicle body area, an included angle between a horizontal line and the handle area 410 may be estimated as a camera roll.

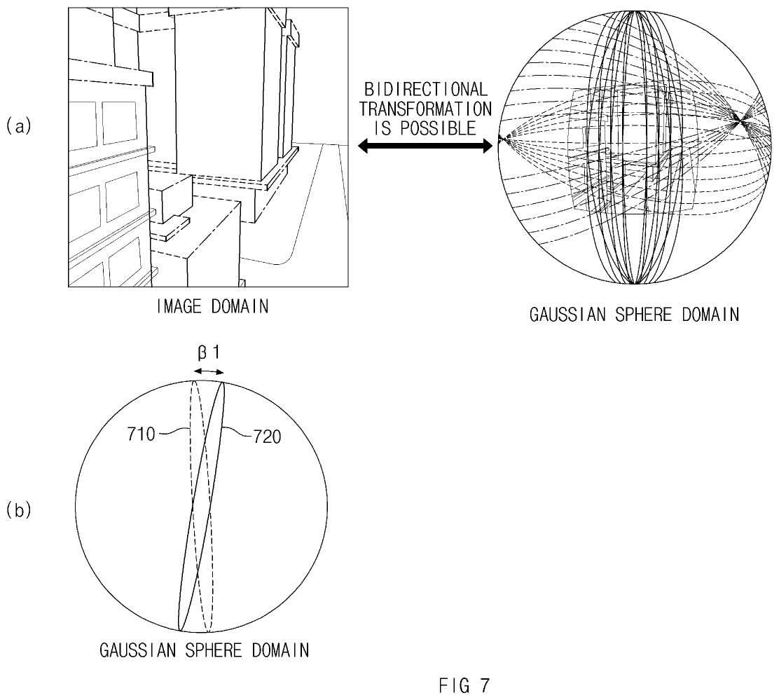

In S330, the roll of the camera may be estimated by generating a 3D circle of the vertical line, generating a 3D circle of the detected edge of the vehicle, and then determining (e.g., calculating) an included angle between the two 3D circles. Here, as the vertical line is perpendicular to the road surface, it may be assumed that the included angle between the vertical line and the edge of the vehicle body area is equivalent to the roll of the camera. The reason for this may be that the vertical line is rotated by the camera roll. The above-described method is a method using MWA, which will be described in further detail with reference to FIG. 7.

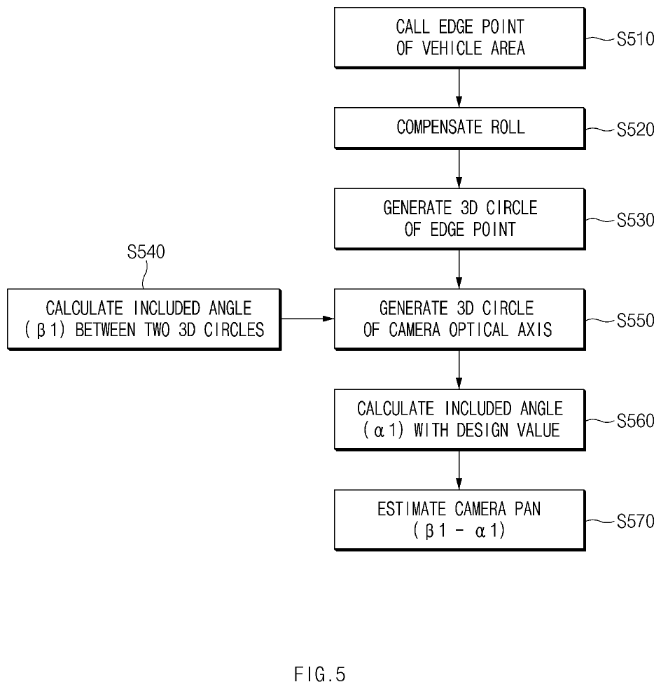

FIG. 5 is an operational flowchart of an example of a process of estimating a camera pan. The camera pan may be estimated using an estimated camera roll.

Referring to FIG. 5, a process of estimating a camera pan may include calling an edge point detected as a vehicle body area and compensating the edge point of the vehicle body area with the estimated camera roll (S510 and S520).

In S520, if the edge point of the vehicle body area is compensated by the estimated camera roll, a 3D circle may be generated for the edge point for which the camera roll is compensated, a 3D circle of the optical axis of the camera may be generated, and an included angle β1 between the two 3D circles may be determined (e.g., calculated) (S530, S540, and S550).

Based on (e.g., using as input) a preset design value for the camera, for example, a camera position in a corresponding vehicle and the edge point compensated with the camera roll, an included angle α1 between a line between the camera and the edge point and the side of the vehicle may be determined (e.g., calculated), and/or a camera pan may be estimated using the difference β1-α1) between the two included angles (S560 and S570).

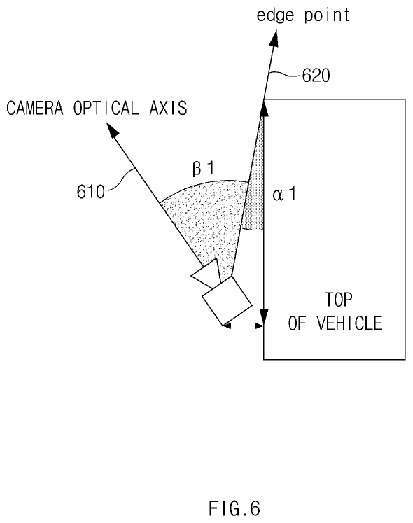

That is, the process of estimating the camera pan, as shown in FIG. 6, may include determining (e.g., calculating) the included angle β1 between a camera optical axis 610 and a line between the camera and an edge point 620, the design value of the camera, for example, the included angle α1 between the line between the camera position and the edge point 620 and a side of the vehicle. The camera pan may be estimated based on a difference between the two included angles β1-α1).

Here, the included angle β1 between the camera optical axis and the edge point may be determined (e.g., calculated) based on Manhattan World Assumption (MWA), as shown in FIG. 7A. That is, based on the MWA, a linear component in an image domain may be expressed as a circle in a Gaussian sphere domain. The linear component in the image domain and the circle in the Gaussian sphere domain may be transformed into each other. That is, as shown in FIG. 7B, the linear corresponding to the camera optical axis 610 may be transformed into or expressed as one circle 710 in the Gaussian sphere domain, and the line 620 between the camera and the edge point may also transformed into or expressed as one circle 720. Therefore, the included angle β1 between the camera optical axis and the edge point of the vehicle body area may be determined (e.g., calculated) using the two circles 710 and 720.

MWA is briefly described as follows. Any plane may be represented by a vector perpendicular to the plane. The six faces of a hexahedron may be expressed with six vectors—ignoring directionality, they may be expressed with three vectors. A virtual space formed only by the faces belonging to the three vectors is called MWA, and any linear component passes through one of the three faces corresponding to one of the three vectors. If the camera posture is changed, the hexahedron also rotates, and the three vectors also rotate. Therefore, the posture of the camera may be estimated by knowing how much the three vectors are rotated. The posture of the camera may be estimated by finding three vectors of the vehicle in the MWA, assuming the vehicle to be a hexahedron. In addition, as shown in FIG. 7A, a method of expressing a linear component of an image domain and a circle of a Gaussian sphere domain is obvious to those skilled in the art, and thus description thereof is omitted.

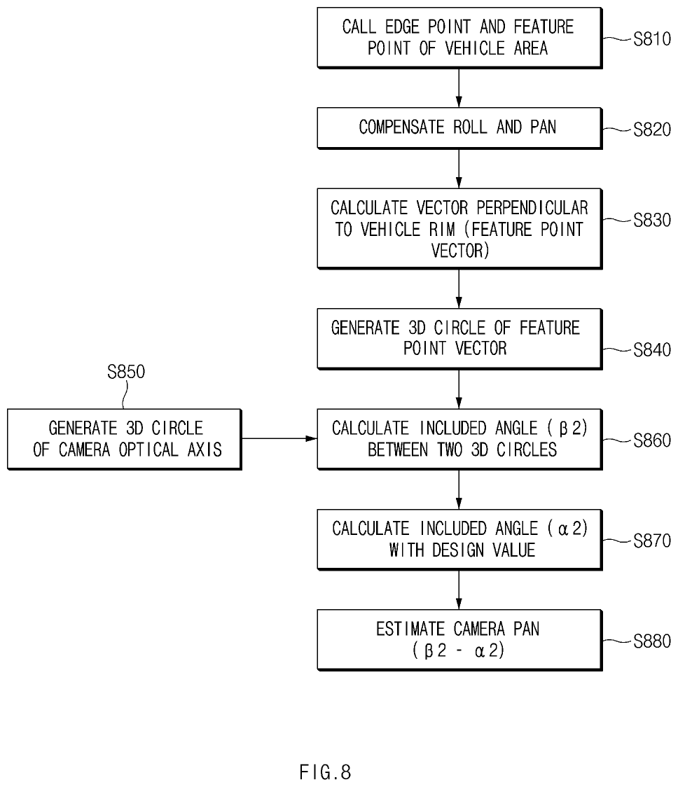

FIG. 8 is an operational flowchart of an example of a process of estimating a camera tilt, which is an operational flowchart of a process of estimating a camera tilt using a camera roll and a camera pan estimated through the above-described processes.

Referring to FIG. 8, a process of estimating a camera tilt may include calling an edge point detected as a vehicle body area and a feature point, for example, a feature point for a handle, and compensating the edge point and the feature point with the camera roll and the camera pan estimated in the above processes (S810 and S820).

Based on the edge point and the feature point compensated by the camera roll and the camera pan, a vector perpendicular to the vehicle body area edge, that is, a feature point vector may be determined (e.g., calculated), a 3D circle for the feature point vector and a 3D circle for the optical axis of the camera may be generated, and an included angle β2 between the two circles may be determined (e.g., calculated) (S830, S840, S850, and S860).

Furthermore, using a preset design value for the camera, for example, a camera position in the vehicle and a feature point vector compensated by a camera roll and a camera pan, an included angle α2 between a line between the camera and the feature point vector and the top surface of the vehicle may be determined (e.g., calculated) and a camera tilt may be estimated using the difference between the two included angles β2-α2) (S870 and S880).

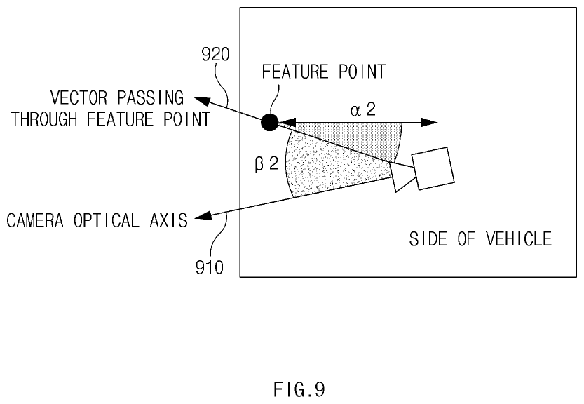

That is, the process of estimating the camera tilt, as shown in FIG. 9, may include determining (e.g., calculating) the included angle β2 between a camera optical axis 910 and the line between the camera and a feature point vector 920, the design value of the camera, for example, the included angle α2 between the feature point vector 920, which is a line between the camera position and the feature point and the top of the vehicle, and estimating the tilt of the camera based on the difference between the two included angles.

As described above, the camera calibration method according to an example of the present disclosure may detect a vehicle body area in an image captured by a vehicle that is driving and estimate the camera posture based on MWA using the slope for the vehicle body area, the feature point, the camera optical axis and the design value. In addition, the camera calibration method according to an example of the present disclosure may utilize all characteristics of a vehicle perpendicular or horizontal to the road surface, for example, the side of the vehicle, the front bumper of the vehicle, the rear bumper of the vehicle, the connection between the glass and the top of the vehicle, or the like, as a vehicle body area captured by a camera.

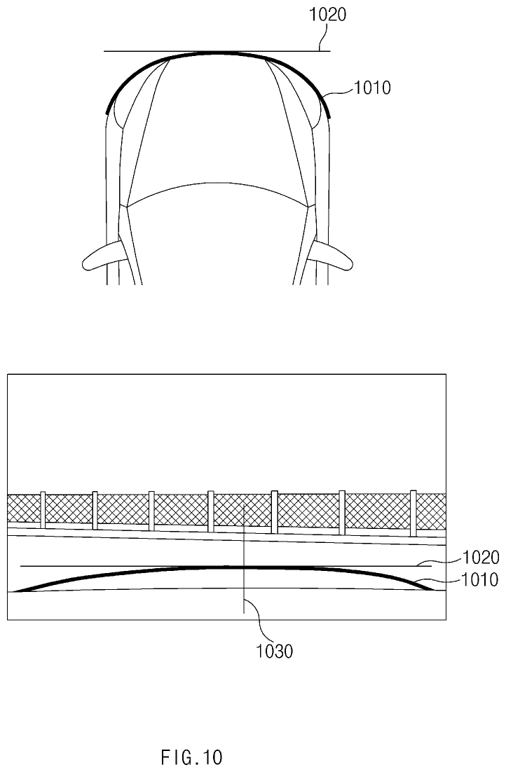

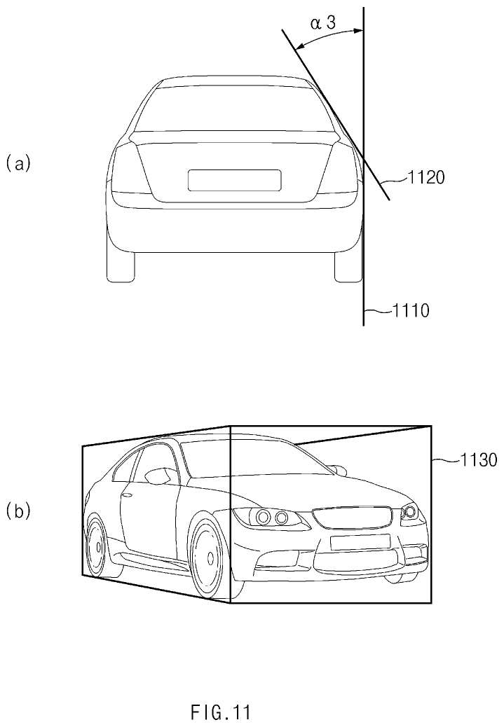

The above description has been made for the case where the MWA is satisfied, and may also be applied to a case where a curve or straight line violating the MWA is detected, which will be described with reference to FIGS. 10 to 11.

FIG. 10 is an exemplary diagram for describing a method of estimating a camera posture in an example violating the Manhattan World Assumption (MWA), which shows an exemplary diagram for describing a method of estimating a camera posture using a curve if a curve violating the MWA is detected.

As shown in FIG. 10A, a curve 1010 may be detected in a vehicle body area detected in an image captured by a camera, and curves that are not straight lines violate MWA. In an example of the present disclosure, a camera posture may be estimated by transforming a curve into a straight line suitable for MWA. For example, a straight line suitable for the MWA and closest to the detected curve may be generated through a drawing of the corresponding vehicle. That is, the relationship between the detected curve 1010 and a straight line 1020 may be known using the drawing of the vehicle, and through this, the detected curve 1010 may be transformed into the straight line 1020 by generating a virtual line 1020 matching the detected curve 1010 for the detected curve 1010. For example, as shown in FIG. 10B, because a front bonnet is symmetrical on the left and right like a decalcomania if the vehicle body area detected in the image is the front bonnet, a straight line 1030 that makes the detected curve 1010 symmetrical is found, and a straight line 1020 perpendicular to the straight line 1030 and tangent to the detected curve 1010 is generated. In this case, the generated straight line 1020 may satisfy MWA. Accordingly, the method according to an example of the present disclosure may estimate the posture of the camera based on a straight line obtained by transforming a curve.

FIG. 11 is an exemplary diagram for describing a method of estimating a camera posture in another example violating the Manhattan World Assumption (MWA), which shows an exemplary diagram for describing a method of estimating a camera posture using calibration of a straight line if a straight line unsatisfying the MWA is detected.

As shown in FIG. 11A, a straight line rather than a curve may be detected in a vehicle body area detected in an image captured by a camera. However, a plane formed by the detected straight line 1120 may violate the MWA. A camera posture may be estimated while satisfying MWA by calibrating a straight line violating MWA using a drawing (e.g., representation/schematic, e.g., of a known shape of the vehicle) of a corresponding vehicle.

For example, as shown in FIG. 11A, if the straight line 1120 on the side of a passenger seat window is detected in the vehicle body area detected in the image, an included angle α3 with a vertical line 1110 may be identified by referring to the drawing of a corresponding vehicle. Therefore, after a roll value with the straight line 1120 is estimated, the camera posture may be estimated using the drawing of the vehicle by calibrating the roll value by the included angle α3, even if a straight line violating the MWA is detected.

As described above, even if a curve or straight line violating the MWA is detected, it possible to estimate the camera posture using all curves and straight lines that are detectable of the vehicle (e.g., in the vehicle body area of an image from the camera) by using the above-described methods.

That is, as shown in FIG. 11B, the camera posture may be estimated using all curves and straight lines detectable (e.g., in an image from the camera) of the vehicle by fitting an arbitrary vehicle segment to a straight line 1130 suitable for the MWA.

As described above, in the camera calibration method according to an example of the present disclosure, if the vehicle body area of a vehicle is detected in an image captured while the vehicle is driving and any one of horizontal direction information or vertical direction information is obtained based on the vehicle body area, the camera posture may be estimated using a straight line obtained by either of the horizontal direction information or the vertical direction information and a vanishing point obtainable while the vehicle is driving.

the camera calibration method, according to an example of the present disclosure, may estimate the camera posture using only direction information from the detected vehicle body area without detecting a vanishing point. For example, horizontal direction information may be obtained from the vehicle body area of the vehicle captured by the camera, such as in an image of the handle or bonnet, and vertical direction information may be obtained from the vehicle body area, such as in an thee of the side of the vehicle.

The camera calibration method according to an example of the present disclosure may transform a curve or straight line violating the MWA into a straight line suitable for the MWA and/or generate a straight line suitable for the MWA based on a curve or straight line detected. The transformed and/or generated line suitable for MWA may be used to detect the camera posture using any (e.g., all) curves and/or straight lines that are detectable in the vehicle body area.

Furthermore, the camera calibration method according to an example of the present disclosure may use an artificial intelligence network, for example, a deep learning-based network, as a method of detecting a vehicle body area in an image captured by a camera. Segmentation may be used, for example, for detecting a vehicle body area using an artificial intelligence network.

In addition, the camera calibration method according to an example of the present disclosure may detect a straight line corresponding to a vanishing line based on the vehicle body area. The camera posture may be estimated using the detected straight line in the vehicle body area and a vanishing point detected in an image captured by the camera while the vehicle is driving.

In addition, the camera calibration method according to an example of the present disclosure may estimate the camera posture based on the horizontal direction information and vertical direction information (e.g., based on the horizontal direction information and the vertical direction information being detected in the vehicle body area vehicle body area). In this case, the method of the present disclosure may estimate the camera posture using only horizontal direction information and the vertical direction information (e.g., without a need to detect and/or use a vanishing line or a vanishing point).

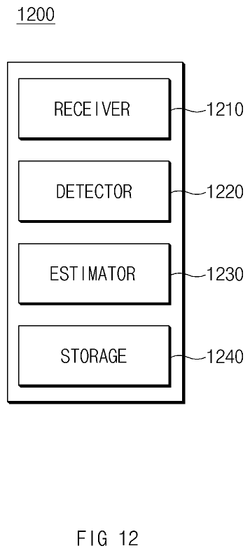

FIG. 12 shows a configuration of a camera calibration apparatus according to another example of the present disclosure, which shows a configuration of an apparatus performing the methods of FIGS. 1 to 11.

Referring to FIG. 12, a camera calibration apparatus 1200 according to another example of the present disclosure may include a receiver 1210, a detector 1220, an estimator 1230, and storage 1240.

The storage 1240 may be a component for storing data related to the technology of the present disclosure. The storage 1240 may store data such as one or more images captured by a camera, algorithms related to the technology of the present disclosure, for example, RANSAC, edge points, RANSAC results, and vehicle drawings, vehicle data, or camera design values, and/or instructions that, when executed, cause the camera calibration apparatus 1200 to perform one or more of the methods disclosed herein.

The receiver 1210 may receive an image catheed by a camera of a vehicle.

The receiver 1210 may receive an image captured by a camera if (e.g., based on) the vehicle is driving at a certain speed or higher.

The detector 1220 may detect a vehicle body area, of the host vehicle, in the image received by the receiver 1210.

The detector 1220 may detect one or more edge points for one or more areas of each of a plurality of areas of the image, measure a number of outliers of the one or more edge points of each area of the one or more areas (e.g., using RANSAC), and determine (e.g., detect), as the vehicle body area, an area, of the image, in which the number of outliers is equal to or less than a preset certain value (e.g., a threshold).

The estimator 1230 may estimate a posture of the camera based on the vehicle body area detected by the detector 1220.

The estimator 1230 may estimate the slope of the vehicle body area based on the vehicle body area, extract a feature point of the vehicle body area, and estimate the posture of the camera using the slope and the feature point.

The estimator 1230 may estimate a slope for an edge of the vehicle body area and estimate a camera roll based on the estimated slope of the edge.

The estimator 1230 may compensate the edge point of the vehicle body area with the estimated roll, generate a 3D circle of the edge point compensated with the roll and a 3D circle of the optical axis of the camera, determine (e.g., calculate) a first included angle between the two 3D circles, determine (e.g., calculate) a second included angle between a preset design value of the camera and the edge point compensated with the roll, and estimate a pan of the camera using the first included angle and the second included angle.

The estimator 1230 may compensate the edge point and feature point of the vehicle body area with the estimated roll and pan, determine (e.g., calculate) a feature point vector perpendicular to the edge using the edge and feature point of the vehicle body area compensated with the roll and pan, determine (e.g., calculate) a third included angle between a 3D circle of the feature point vector and a 3D circle of the optical axis of the camera, determine (e.g., calculate) a fourth included angle between a design value of the camera and the feature point compensated with the roll and pan, and estimate a tilt of the camera using the third and fourth included angles.

The estimator 1230 may detect a straight line corresponding to a vanishing line based on the vehicle body area and estimate the posture of the camera using the detected straight line and the vanishing point detected through an image of the vehicle while driving.

If a curve is detected through the vehicle body area, the estimator 1230 may generate a virtual line corresponding to a straight line using the curve and curve information for the vehicle body area, for example, drawing information of the vehicle and estimate the camera posture using the virtual line and the vanishing point.

The estimator 1230 may estimate the camera posture based on horizontal direction information and vertical direction information if the horizontal direction information and the vertical direction information of the vehicle body area are detected based on the vehicle body area.

Even if a description is omitted in the apparatus according to another example of the present disclosure, the apparatus according to another example of the present disclosure may include all of the contents described in the methods of FIGS. 1 to 11, which is obvious to those skilled in the art.

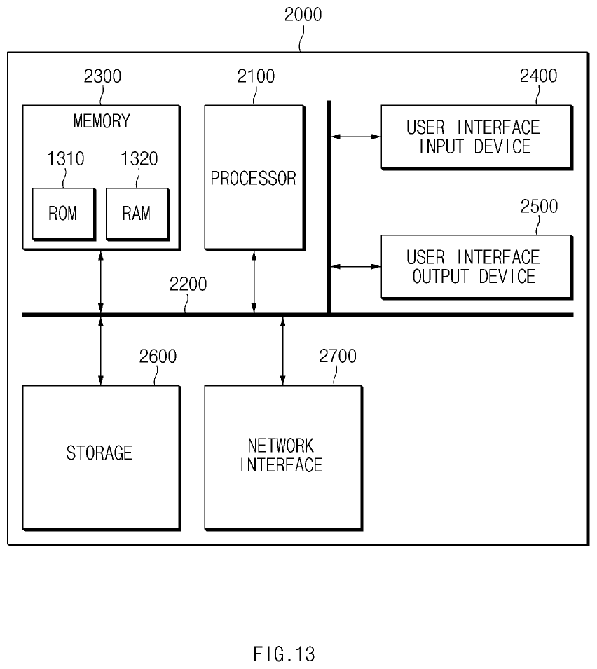

FIG. 13 is a block diagram of a computing system for executing a camera calibration method of the present disclosure.

Referring to FIG. 13, a method of estimating a vanishing point according to another example of the present disclosure described above may be implemented through a computing system. A computing system 2000 may include at least one processor 2100, a memory 2300, a user interface input device 2400, a user interface output device 2500, storage 2600, and a network interface 2700, which are connected with each other via a system bus 2200.

The processor 2100 may be a central processing unit (CPU) or a semiconductor device that processes instructions stored in the memory 2300 and/or the storage 2600. The memory 2300 and the storage 2600 may include various types of volatile or non-volatile storage media. For example, the memory 2300 may include a ROM (Read Only Memory) 2310 and a RAM (Random Access Memory) 2320.

Thus, the operations of the method or the algorithm described in connection with the examples disclosed herein may be embodied directly in hardware or a software module executed by the processor 2100, or in a combination thereof. The software module may reside on a storage medium (that is, the memory 2300 and/or the storage 2600) such as a RAM, a flash memory, a ROM, an EPROM, an EEPROM, a register, a hard disk, a removable disk, and a CD-ROM. The exemplary storage medium may be coupled to the processor 2100, and the processor 2100 may read information out of the storage medium and may record information in the storage medium. Alternatively, the storage medium may be integrated with the processor 2100. The processor 2100 and the storage medium may reside in an application specific integrated circuit (ASIC). The ASIC may reside within a user terminal. In another case, the processor 2100 and the storage medium may reside in the user terminal as separate components.

The present disclosure has been made to solve the above-mentioned problems occurring in the prior art while advantages achieved by the prior art are maintained intact.

An aspect of the present disclosure provides a camera calibration method and apparatus capable of estimating the posture of a camera based on the vehicle shape or vehicle body area of a vehicle captured while the vehicle is driving.

An aspect of the present disclosure provides a camera calibration method and apparatus capable of estimating the posture of a camera using information on the vehicle body area of a vehicle captured by the camera, for example, at least one of horizontal direction information and vertical direction information, and a vanishing point that are obtainable while the vehicle is driving.

An aspect of the present disclosure provides a camera calibration method and apparatus capable of estimating the posture of a camera using only two pieces of direction information without detecting a vanishing point if horizontal direction information for the vehicle body area of the vehicle captured by the camera, such as information on the handle or bonnet, and vertical direction information, such as information on the side of the vehicle.

An aspect of the present disclosure provides a camera calibration method and apparatus capable of estimating (e.g., configured to estimate) the posture of a camera by utilizing all curves and straight lines that are detectable in a vehicle by performing transformation into, generating, or performing calibration for a straight line suitable for Manhattan World Assumption (MWA) if a curve and straight line violating the MWA is detected.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a camera calibration method includes receiving an image captured by a camera of a vehicle, detecting a vehicle body area of the vehicle from the image, and estimating a posture of the camera based on the vehicle body area.

The detecting of the vehicle body area may include detecting one or more edge points for one or more areas of a plurality of areas of the image, measuring a number of outliers of the edge points in each of the one or more areas using RANSAC (RANdom Sample Consensus), and detecting (e.g., determine), as the vehicle body area, an area, of the one or more areas of the image, in which a number of outliers is less than or equal to a preset value (e.g., a threshold value).

the estimating of the posture of the camera may include estimating a slope, of the vehicle body area, based on the vehicle body area; extracting a feature point of the vehicle body area; and estimating the posture of the camera using the slope and the feature point.

The estimating of the posture of the camera may include estimating a slope of a edge of the vehicle body area and estimating a roll of the camera based on the estimated slope of the edge.

The estimating of the posture of the camera may include compensating an edge point of the vehicle body area with the estimated roll, generating a 3D circle of the edge point compensated with the roll and a 3D circle of an optical axis of the camera, determining (e.g., calculating) a first included angle between the two 3D circles, calculating a second included angle between a preset design value of the camera and the edge point compensated with the roll, and estimating (e.g., determining and/or calculating an estimate of) a pan of the camera using the first included angle and the second included angle.

The estimating of the posture of the camera may include compensating the edge point and the feature point of the vehicle body area with the estimated roll and estimated pan, calculating a feature point vector perpendicular to the edge using the edge and the feature point of the vehicle body area compensated with the roll and pan, calculating a third included angle between a 3D circle of the feature point vector and a 3D circle of the optical axis of the camera, calculating a fourth included angle between the design value of the camera and the feature point compensated with the roll and pan, and estimating a tilt of the camera using the third and fourth included angles.

The estimating of the posture of the camera may include detecting a straight line corresponding to a vanishing line based on the vehicle body area, and estimating the posture of the camera using the detected straight line and a vanishing point detected through the image while the vehicle is driving.

The estimating of the posture of the camera may include generating a virtual line corresponding to the straight line using a curve and curve information for the vehicle body area, and estimating the posture of the camera using the virtual line and the vanishing point if the curve is detected through the vehicle body area.

The estimating of the posture of the camera may include estimating the posture of the camera based on horizontal direction information and vertical direction information if the horizontal direction information and the vertical direction information for the vehicle body area are detected based on the vehicle body area.

According to the present disclosure, a camera calibration apparatus may include a receiver configured to receive an image captured by a camera of a vehicle, a detector configured to detect, in the image, a vehicle body area of the vehicle, and an estimator configured to estimates a posture of the camera based on the detected vehicle body area.

The detector may detect an edge point in one or more areas, of a plurality of areas in the image; determine (e.g., measure), for each of the one or more areas, a number of outlier edge point for the each of the one or more areas (e.g., using RANSAC (RANdom SAmple Consensus)), and detect (e.g., determine) an area (e.g., cumulative of the one or more areas) in which the number of outliers is less than or equal to a preset value, as the vehicle body area (e.g., part of the vehicle body area.

The estimator may estimate a slope of the vehicle body area based on the vehicle body area, extract a feature point of the vehicle body area, and estimate the posture of the camera using the slope and the feature point.

The estimator may estimate a slope of a edge of the vehicle body area and estimate a roll of the camera based on the estimated slope of the edge.

The estimator may compensate an edge point of the vehicle body area with the estimated roll, generating a 3D circle of the edge point compensated with the roll and a 3D circle of an optical axis of the camera, determine (e.g., calculate) a first included angle between the two 3D circles, determine (e.g., calculate) a second included angle between a preset design value of the camera and the edge point compensated with the roll, and estimate a pan of the camera using the first included angle and the second included angle.

The estimator may compensate the edge point and the feature point of the vehicle body area with the estimated roll and estimated pan, determine (e.g., calculate) a feature point vector perpendicular to the edge using the edge and the feature point of the vehicle body area compensated with the roll and pan, determine (e.g., calculate) a third included angle between a 3D circle of the feature point vector and a 3D circle of the optical axis of the camera, determine (e.g., calculate) a fourth included angle between the design value of the camera and the feature point compensated with the roll and pan, and estimate a tilt of the camera using the third and fourth included angles.

The estimator may detect a straight line corresponding to a vanishing line based on the vehicle body area, and estimate the posture of the camera using the detected straight line and a vanishing point detected through the image while the vehicle is driving.

The estimator may generate a virtual line corresponding to the straight line using a curve and curve information for the vehicle body area, and estimate the posture of the camera using the virtual line and the vanishing point if the curve is detected through the vehicle body area.

The estimator may estimate the posture of the camera based on horizontal direction information and vertical direction information if the horizontal direction information and the vertical direction information for the vehicle body area are detected based on the vehicle body area.

The features briefly summarized above for the present disclosure are merely exemplary aspects of the detailed description of the present disclosure to be described below, and do not limit the scope of the present disclosure.

The above description is merely illustrative of the technical idea of the present disclosure, and various modifications and variations may be made without departing from the essential characteristics of the present disclosure by those skilled in the art to which the present disclosure pertains. Accordingly, the examples disclosed in the present disclosure is not intended to limit the technical idea of the present disclosure but to describe the present disclosure, and the scope of the technical idea of the present disclosure is not limited by the example. The scope of protection of the present disclosure should be interpreted by the following claims, and all technical ideas within the scope equivalent thereto should be construed as being included in the scope of the present disclosure.

According to the present disclosure, it is possible to provide a camera calibration method and apparatus capable of estimating a camera posture based on the vehicle shape or vehicle body area of a vehicle captured while the vehicle is driving.

According to the present disclosure, it is possible to estimate the posture using information on the vehicle body area of a vehicle captured by the camera, for example, at least one of horizontal direction information and vertical direction information, and a vanishing point that are obtainable while the vehicle is driving.

According to the present disclosure, it is possible to estimate the camera posture using only two pieces of direction information without detecting a vanishing point if horizontal direction information for the vehicle body area of the vehicle captured by the camera, such as information on the handle or bonnet, and vertical direction information, such as information on the side of the vehicle are obtainable.

According to the present disclosure, it is possible to transform a curve or straight line violating the MWA into, generate, or calibrate a straight line suitable for the MWA if the curve or straight line is detected, thereby estimating the camera posture using all curves and straight lines that are detectable in the vehicle.

The effects obtainable in the present disclosure are not limited to the aforementioned effects, and any other effects not mentioned herein will be clearly understood from the following description by those skilled in the art to which the present disclosure pertains.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method comprising:
receiving an image captured by a camera of a vehicle;
detecting, in the image, a vehicle body area of the vehicle;
estimating, based on a slope of an edge associated with the vehicle body area, a posture of the camera; and
performing image recognition on a calibrated image, wherein the calibrated image is based on a second image acquired by the camera calibrated based on the estimated posture of the camera.

2. The method of claim 1, wherein the detecting the vehicle body area comprises:
detecting an edge point in one or more areas of a plurality of areas in the image;
determining, using RANSAC (RANdom SAmple Consensus), a number of outlier edge points in each area of the one or more areas; and
detecting, as the vehicle body area, an area, of the one or more areas, having a corresponding number of outlier edge points less than or equal to a preset value.

3. The method of claim 1, wherein the estimating the posture of the camera comprises:
estimating the slope of the edge associated with the vehicle body area;
extracting a feature point of the vehicle body area; and
estimating, based on the slope and the feature point, the posture of the camera.

4. The method of claim 3, wherein the edge associated with the vehicle body area is an edge of the vehicle body area, and wherein the estimating the posture of the camera comprises:
estimating, based on the estimated slope of the edge, a roll of the camera.

5. The method of claim 4, wherein the estimating the posture of the camera comprises:
compensating, based on the estimated roll, an edge point of the vehicle body area;
generating:
a three-dimensional (3D) circle based on the compensated edge point, and
a 3D circle of an optical axis of the camera;
determining a first included angle between the two 3D circles;
determining a second included angle between a preset design value of the camera and the compensated edge point; and
estimating, based on the first included angle and the second included angle, a pan of the camera.

6. The method of claim 5, wherein the compensating the edge point further comprises compensating the edge point based on the estimated pan, and wherein the estimating of the posture of the camera further comprises:
compensating, based on the estimated roll and the estimated pan, the feature point of the vehicle body area;
determining, based on the compensated edge point and the compensated feature point, a feature point vector perpendicular to the edge of the vehicle body area,
determining a third included angle between a 3D circle corresponding to the feature point vector and a 3D circle corresponding to the optical axis of the camera;
determining a fourth included angle between the design value of the camera and the compensated feature point; and
estimating, based on the third and fourth included angles, a tilt of the camera.

7. The method of claim 1, wherein the estimating the posture of the camera comprises:
detecting a straight line corresponding to a vanishing line determined based on the vehicle body area; and
estimating, based on the detected straight line and a vanishing point based on the vanishing line, the posture of the camera while the vehicle is being driven.

8. The method of claim 7, wherein the estimating of the posture of the camera comprises:
generating, based on a curve detected in the vehicle body area, a virtual line corresponding to the straight line; and
estimating, based on the virtual line and the vanishing point, the posture of the camera.

9. The method of claim 1, wherein the estimating the posture of the camera comprises:
estimating, based on horizontal direction information and vertical direction information, the posture of the camera, wherein the horizontal direction information and the vertical direction information are detected based on the vehicle body area.

10. An apparatus comprising:
a receiver configured to receive an image captured by a camera of a vehicle;
a detector configured to detect, in the image, a vehicle body area of the vehicle; and
an estimator configured to estimate, based on a slope of an edge associated with the vehicle body area, a posture of the camera,
wherein the apparatus is configured to perform image recognition on a calibrated image, wherein the calibrated image is based on a second image acquired by the camera calibrated based on the estimated posture of the camera.

11. The apparatus of claim 10, wherein the detector is configured to:
detect an edge point in one or more areas of a plurality of areas in the image;
determine, using RANSAC (RANdom Sample Consensus), a number of outlier edge points in each area of the one or more areas; and
detect, as the vehicle body area, an area, of the one or more areas, having a corresponding number of outlier edge points less than or equal to a preset value.

12. The apparatus of claim 10, wherein the estimator is configured to:
estimate the slope of the edge associated with the vehicle body area;
extract a feature point of the vehicle body area; and
estimate, based on the slope and the feature point, the posture of the camera.

13. The apparatus of claim 12, wherein the edge associated with the vehicle body area is an edge of the vehicle body area, and wherein the estimator is configured to:
estimate, based on the estimated slope of the edge, a roll of the camera.

14. The apparatus of claim 13, wherein the estimator is configured to:
compensate, based on the estimated roll, an edge point of the vehicle body area;
generate:
a 3D circle of the compensated edge point, and
a 3D circle of an optical axis of the camera;
determine a first included angle between the two 3D circles;
determine a second included angle between a preset design value of the camera and the compensated edge point; and
estimate, based on the first included angle and the second included angle, a pan of the camera.

15. The apparatus of claim 14, wherein the estimator is configured to:
compensate, based on the estimated roll and pan, the edge point and the feature point of the vehicle body area;
determine, based on the compensated edge and the compensated feature point, a feature point vector perpendicular to the edge of the vehicle body area;
determine a third included angle between a 3D circle corresponding to the feature point vector and a 3D circle of the optical axis of the camera;
determine a fourth included angle between the design value of the camera and the compensated feature point; and
estimate, based on the third and fourth included angles, a tilt of the camera.

16. The apparatus of claim 10, wherein the estimator is configured to:
detect a straight line corresponding to a vanishing line determined based on the vehicle body area; and
estimate, based on the detected straight line and a vanishing point determined based on the vanishing line, the posture of the camera while the vehicle is being driven.

17. The apparatus of claim 16, wherein the estimator is configured to:
generate, based on a curve detected in the vehicle body area, a virtual line corresponding to the straight line; and
estimate, based on the virtual line and the vanishing point, the posture of the camera.

18. The apparatus of claim 10, wherein the estimator is configured to:
estimate, based on horizontal direction information and vertical direction information, the posture of the camera, wherein the horizontal direction information and the vertical direction information are detected based on the vehicle body area.
